(19) United States
(12) Patent Application Publication
(10) Pub. No.: US 2007/0204267 A1
(43) Pub. Date: Aug. 30, 2007

(54) Throttling prefetching in a processor

(76) Inventors: Michael F. Cole, El Dorado Hills, CA (US); Franklin Huang, Portland, OR (US)

Correspondence Address: TROP PRUNER & HU, PC, 1616 S. VOSS ROAD, SUITE 750, HOUSTON, TX, 77057-2631, US

(21) Appl. No.: 11/364,678

(22) Filed: Feb. 28, 2006

(51) Int. Cl. G06F 9/46

(52) U.S. Cl. 718/100

(57) ABSTRACT

In one embodiment, the present invention includes a method for counting demand accesses of a first thread associated with a prefetch detector to obtain a count value, accumulating the count value with an accumulated count at detector deallocation, and throttling prefetching in the first thread based on an average obtained from the accumulated count. An override mechanism may permit prefetching based on demand accesses associated with a particular prefetch detector. Other embodiments are described and claimed.

### BACKGROUND

Embodiments of the present invention relate to operation of a processor, and more particularly to prefetching data for use in a processor.

Processors perform operations on data in response to program instructions. Today's processors operate at ever-increasing speeds, allowing operations to be performed rapidly. Data needed for operations must be present in the processor. If the data is missing from the processor when it is needed, a latency, which is the time it takes to load the data into the processor, occurs. Such a latency may be low or high, depending on where the data is obtained from within various levels of a memory hierarchy. Accordingly, prefetching schemes are used to obtain data or instructions and provide them to a processor prior to their use in a processor's execution units. When this data is readily available to an execution unit, latencies are reduced and increased performance is achieved.

Often times a prefetching scheme will prefetch information and store it in a cache memory of the processor. However, such prefetching and storage in a cache memory can cause the eviction of other data from the cache memory. The data evicted from the cache, when needed, can only be obtained at the expense of a long latency. Such eviction and resulting delays are commonly referred to as cache pollution. If the prefetched information is not used, the prefetch and eviction of data provides no benefit. In addition to potential performance slowdowns due to cache pollution, excessive prefetching can cause increased bus traffic, which leads to further bottlenecks, reducing performance.

While for many applications, prefetching is a critical component for improved processing performance, unconstrained prefetching can actually harm performance in some applications. This is especially so as processors expand to include multiple cores, and multiple threads that execute per core. Accordingly, unconstrained prefetching schemes that work well in a single core and/or single-threaded environment can negatively impact performance in a multi-core and/or multi-threaded environment.

### BRIEF DESCRIPTION OF THE DRAWINGS

FIG. 1 is a block diagram of a processor in a system in accordance with one embodiment of the present invention.

FIG. 2 is a flow diagram of a method in accordance with one embodiment of the present invention.

FIG. 3 is a flow diagram of a method for overriding a throttling policy in accordance with an embodiment of the present invention.

FIG. 4 is a block diagram of a prefetch throttle controller in accordance with an embodiment of the present invention.

FIG. 5 is a block diagram of a system in accordance with an embodiment of the present invention.

### DETAILED DESCRIPTION

In various embodiments, mechanisms may be provided to enable throttling of prefetching. Such throttling may be performed on a per-thread basis to enable fine-grained control of prefetching activity. In this way, prefetching may be performed when it improves thread performance, while prefetching may be constrained in situations in which prefetching would negatively impact performance. By performing an analysis of prefetching, a mechanism in accordance with an embodiment of the present invention may set a throttling policy, e.g., on a per-thread basis to either allow prefetching in an unconstrained manner or to throttle such prefetching. In various embodiments, different manners of throttling prefetching may be realized, including disabling of prefetching, reducing an amount of prefetching or in other such ways. In some implementations, a prefetching throttling policy may be used to initialize prefetch detectors, which are tables or the like allocated to particular memory regions. In this way, these prefetch detectors may have a throttling policy set on allocation that enables throttling to occur from allocation, even where the prefetch detector lacks information to make a throttling decision on its own. Accordingly, ill effects potentially associated with unconstrained prefetching may be limited where a prefetch detector is allocated with an initial throttling policy set to a throttled state.

Various manners of implementing prefetch throttling analysis may be performed in different embodiments using various combinations of hardware, software and/or firmware. Furthermore, implementations may exist in many different processor architecture types, and in connection with different prefetching schemes, including such schemes that do not use detectors.

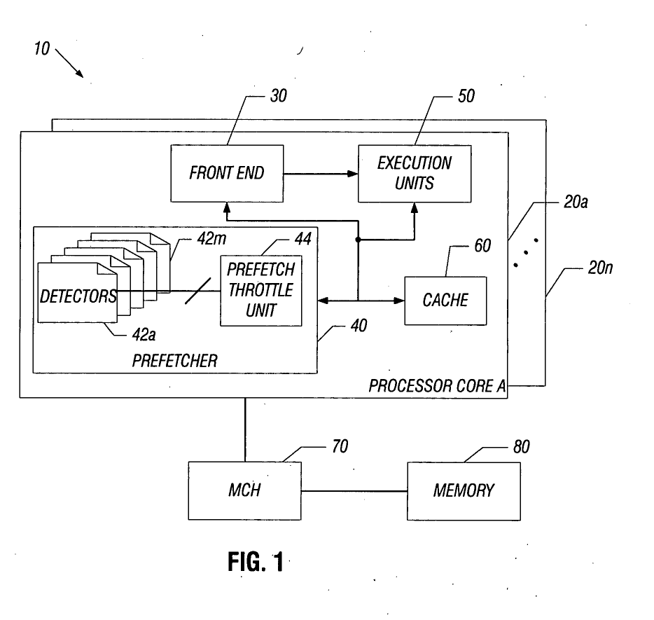

Referring now to FIG. 1, shown is a block diagram of a processor in a system in accordance with one embodiment of the present invention. As shown in FIG. 1, system 10 includes a plurality of processors 20a-20n (generically processor 20, with a representative processor core A shown in FIG. 1). The multiple processors may be cores of a multi-core processor or may be single core processors of a multiprocessor system. Processor 20 is coupled to a memory controller hub (MCH) 70, to which a memory 80 is coupled. In one embodiment, memory 80 may be a dynamic random access memory (DRAM), although the scope of the present invention is not so limited. While described with these limited components for ease of illustration, it is to be understood that system 10 may include many other components that may be coupled to processor 20, MCH 70, and memory 80 via various buses or other interconnects, such as point-to-point interconnects, for-example.

Still referring to FIG. 1, processor 20 includes various hardware to enable processing of instructions. Specifically, as shown in FIG. 1, processor 20 includes a front end 30. Front end 30 may be used to receive instructions and decode them, e.g., into microoperations (pops) and provide the pops to a plurality of execution units 50. Execution units 50 may include various execution units including, for example, integer and floating-point units, single instruction multiple data (SIMD) units, address generation units (AGU), among other such units. Furthermore, execution units 50 may include one or more register files and associated buffers, queues and the like.

Still referring to FIG. 1, a prefetcher 40 and a cache memory 60 are further coupled to front end 30 and execution units 50. Cache memory 60 may be used to temporarily store instructions and/or data. In some embodiments, cache memory 60 may be a unified storage including both instruction and data information, while in other embodiments separate caches for instructions and data may be present. When front end 30 and/or execution units 50 seek information, they may first determine whether such information is already present in cache memory 60. For example, recently used information may be stored in cache memory 60 because there is a high likelihood that the same information will again be requested. While not shown in the embodiment of FIG. 1, it is to be understood that cache memory 60 or another location in processor 20 may include a cache controller to search for the requested information based on tag information. If the requested information is present, it may be provided to the requesting location, e.g., front end 30 or execution units 50. Otherwise, cache memory 60 may indicate a cache miss.

Demand accesses corresponding to processor requests may be provided to prefetcher 40. In one embodiment all such demand accesses may be sent, while in other embodiments only demand accesses associated with cache misses are sent to prefetcher 40. As shown in FIG. 1, prefetcher 40 includes a plurality of detectors 42a-m (generically detector 42) which are coupled to a prefetch throttle unit 44. Prefetcher 40 may operate to analyze demand accesses issued within front end 30 and/or execution units 50 and discern any patterns in the accesses in order to prefetch desired data from memory 80, such that latencies between requests for data and availability of the data for use in execution units 50 can be avoided. However, as described above, particularly in a multi-threaded and/or multi-core environment, unconstrained prefetching can negatively impact performance. For example, unconstrained prefetching can cause excessive bus traffic, reducing bandwidth. Furthermore, unconstrained prefetching can cause excessive evictions of data from cache memory 60. When needed data has been evicted, performance decreases, as the latency associated with obtaining the needed data from memory 80 (for example) is incurred.

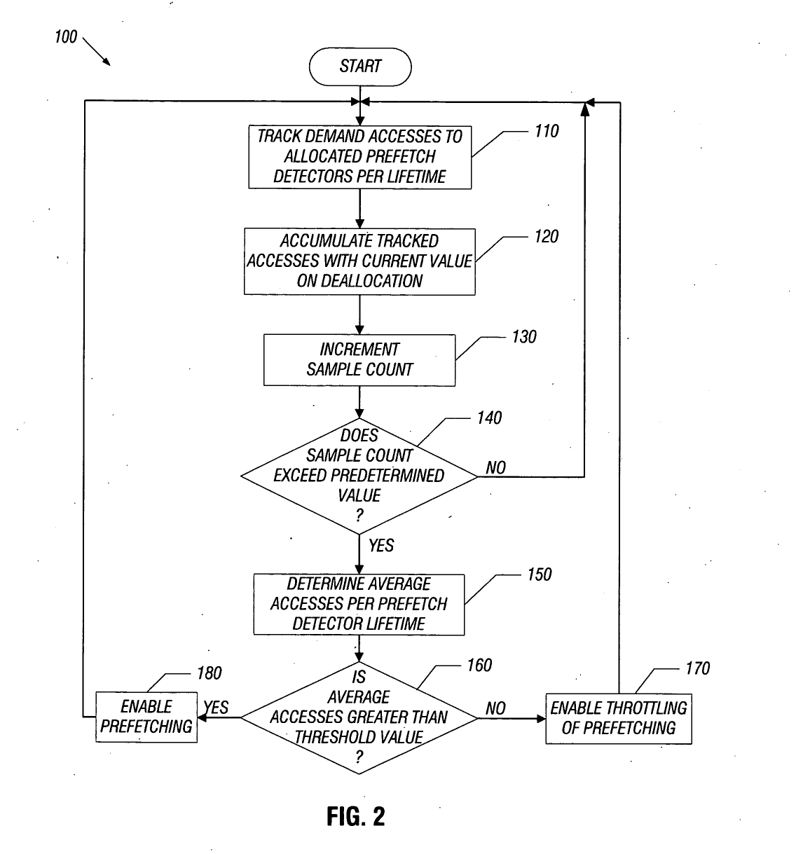

Accordingly, to prevent such ill effects embodiments of the present invention may analyze demand accesses to determine whether prefetching should be throttled. Demand accesses are requests issuing from processor components resulting from instruction stream execution for data at particular memory locations. Various manners of determining whether to throttle prefetching can be implemented. Referring now to FIG. 2, shown is a flow diagram of a method in accordance with one embodiment of the present invention. As shown in FIG. 2, method 100 may be used to analyze demand access behavior and determine an appropriate throttling policy for a prefetcher.

As shown in FIG. 2, method 100 may begin by tracking demand accesses to allocated prefetch detectors over their lifetimes (block 110). That is, multiple prefetch detectors may be present in a prefetcher. Each such detector may be allocated to a range of memory (e.g., corresponding to a group of fixed-size pages). When an initial access is made to a page of memory, a corresponding detector is allocated for the page. The allocated detector may monitor demand accesses to the page and generate prefetches for addresses within the page. Such prefetching may be performed according to various algorithms based, for example, on patterns of the demand accesses. Because there are a fixed number of detectors, when the detectors are all allocated, one of the detectors must be deallocated from a current page or memory region and reallocated to a new memory region. Accordingly, a lifetime of a detector refers to a time period between its allocation to a memory region and its later deallocation from that memory region.

Still referring to FIG. 2, when a lifetime of a detector is completed (i.e., on deallocation) the tracked accesses of the detector, which correspond to the number of demand accesses for the associated memory region during the detector's lifetime, may be accumulated with a current value corresponding to tracked accesses for other deallocated lifetimes (block 120). Also on deallocation, a sample count may be incremented (block 130). Next, it may be determined whether a sufficient sample size of lifetimes is present. More specifically, at diamond 140, it may be determined whether the sample count exceeds a predetermined value (diamond 140). While the value of such a threshold may vary in different embodiments, in one implementation the desired amount of lifetimes may correspond to a power of 2, for ease of handling. For example, in different embodiments a sample size of 16 or 32 lifetimes may be used as the threshold value.

If at diamond 140 the sample count is determined not to exceed the predetermined value, control passes back to block 110, where further demand accesses are tracked in additional allocated detectors. If instead at diamond 140 it is determined that the desired sample size of lifetimes is present, control passes to block 150. There the average accesses per prefetch detector lifetime may be determined (block 150). As one example determination, a total amount of accesses accumulated may be averaged by dividing the total accesses by the sample size. In embodiments in which the sample size is a power of 2, this operation may be effected by taking only the desired number of most significant bits of the accumulated value. For example, the accumulated value may be taken to 11 bits. However, for a desired lifetime sample size of 32, only the 6 most significant bits may be used to obtain the average. Also at block 150, the sample count (and the accumulation value) may be reset.

Still referring to FIG. 2, next control passes to diamond 160. There it may be determined whether the average accesses per detector is greater than a threshold value (diamond 160). This threshold value may correspond to a value determined, e.g., experimentally, of a number of accesses at which prefetching likely aids or improves program operation, while at levels below such threshold prefetching could potentially decrease system performance. Accordingly, if it is determined that the average number of accesses is greater than this threshold value, prefetching may be enabled (block 180). In contrast, if the average number of accesses is below the threshold value, throttling of prefetching instead may be enabled (block 170).

Then from either of blocks 170 and 180, control may pass back to block 110, discussed above. Thus method 100 may be continuously performed during operation such that dynamic analysis of demand accesses is routinely performed so that prefetching or throttling of prefetching may occur based on the nature of demand accesses currently being performed in a system. Because demand accesses and the characteristics of corresponding detector behavior is temporal in nature, such dynamic analysis and control of throttling may improve performance. For example, sometimes an application may switch from a predominant behavior to a transient behavior with respect to memory accesses. Embodiments of the present invention may thus set an appropriate throttling policy based on the nature of demand accesses currently being made.

While certain applications may exhibit a given demand access pattern that in turn either enables prefetching or causes throttling of prefetching, transient behavior of the application may change demand access patterns, at least for a given portion of execution. Accordingly, in various embodiments prefetch detectors in accordance with an embodiment of the present invention may include override logic to override a throttling policy when a current demand access pattern would be improved by prefetching.

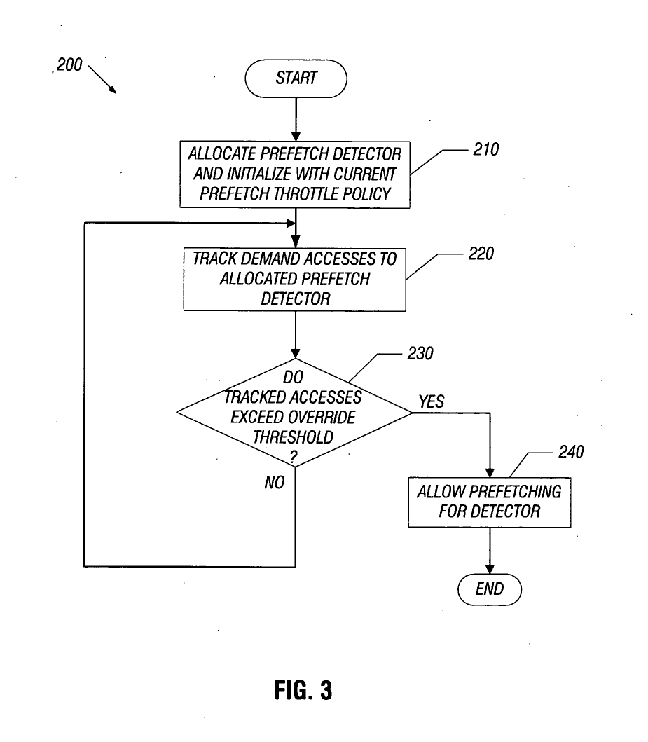

Referring now to FIG. 3, shown is a flow diagram of a method of overriding a throttling policy in accordance with an embodiment of the present invention. As shown in FIG. 3, method 200 may begin by allocating a prefetch detector and initializing the detector with a current prefetch throttle policy (block 210). That is, upon a demand access to a given region of memory, a prefetch detector may be allocated to that region. Furthermore, because no information regarding demand accesses to that region of memory is currently known, the prefetch detector may be initialized with the current global prefetch throttling policy. Thus, prefetches may be throttled if the current global prefetch throttle policy for the given thread is set.

Still referring to FIG. 3, next demand accesses may be tracked for the allocated prefetch detector (block 220). Accordingly, a count may be maintained for every demand access to the region of memory allocated to the prefetch detector. At each increment of the count, it may be determined whether the tracked accesses exceed an override threshold (diamond 230). That is, the number of tracked demand accesses in the lifetime of the prefetch detector may be compared to an override threshold. This override threshold may vary in different embodiments, however, in some implementations, the threshold may be set in the same general range as the threshold used in determination of a prefetch throttling policy. For example, in some implementations, the override threshold may be between approximately 5 and 15 accesses for a detector having a depth of between approximately 32 and 128 entries (i.e., demand accesses), although the scope of the present invention is not so limited. If it is determined at diamond 230 that the tracked accesses do not exceed the override threshold, control passes back to block 220, discussed above.

If instead at diamond 230, it is determined that the tracked accesses do exceed the override threshold, control passes to block 240. There, prefetching may be allowed for prefetch addresses generated for the memory region thread associated with the detector (block 240). Accordingly, such an override mechanism allows for prefetching of accesses associated with a given detector even where the thread associated with that detector has a throttling policy set. In this way, transient behavior of the thread that indicates, e.g., streaming accesses may support prefetching, improving performance by reducing latencies to obtain data from memory or a throttling policy may be overridden when a thread performs multiple tasks having different access profiles. While described with this particular implementation in the embodiment of FIG. 3, it is to be understood that the scope of the present invention is not so limited, and other manners of overriding a prefetch throttling policy may be effected in other embodiments.

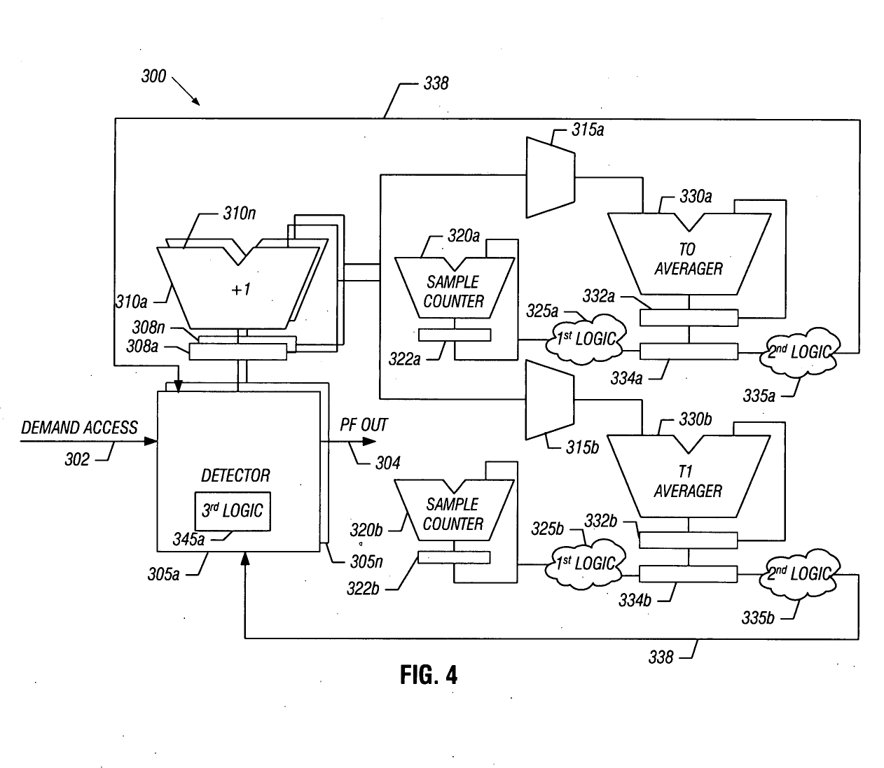

In different implementations, prefetch throttling determinations and potential overriding of such policies may be implemented using various hardware, software and/or firmware. Referring now to FIG. 4, shown is a block diagram of a prefetch throttle controller in accordance with an embodiment of the present invention.

As shown in FIG. 4, prefetcher 300 may include a plurality of detectors 305a-305n (generically detector 305). Each detector 305 may be allocated upon an initial demand access to a given memory range (e.g., a prefetch page). The initial demand access and following demand accesses for the same page are thus tracked within detector 305. To maintain a track of each such access, one of a plurality of accumulators 310a-310n (generically accumulator 310) may be associated with each detector 305. The number of accesses may range from 1 (i.e., the lowest number that represents an original demand access used to allocate a detector) to N, where N may correspond to the number of entries (i.e., cachelines) of a page corresponding to a detector. Note that while it is possible that some lines in a detector may be accessed multiple times, and thus the number of accesses per detector may exceed N, some embodiments may cap a total number of accesses at N. In various embodiments, the detector size may be 32 to 128 cachelines, although the scope of the present invention is not so limited. On each demand access to a page corresponding to a detector 305, the corresponding accumulator 310 may increment its count. As shown, registers 308a-308n (generically register 308) may be coupled between each detector 305 and accumulator 310 to store the current accumulated value.

As shown in FIG. 4, detector 305 may be adapted to receive incoming demand accesses via a signal line 302. Based on such demand accesses, logic within detector 305 may generate one or more prefetch addresses that are to be sent via a prefetch output line 304. The prefetch address(es) may be sent to a memory hierarchy to obtain data at the prefetch location for storage in prefetcher 300 or an associated buffer. However, to prevent negative performance effects from unconstrained prefetching, prefetcher 300 may use various control structures to effect prefetch throttling in given environments. As will be discussed further below, each detector 305 further includes a third logic unit 345 (generically, and a representative logic 345a shown in FIG. 4) which may be used to perform override mechanisms in accordance with an embodiment of the present invention.

As shown in FIG. 4, prefetcher 300 may include separate paths for each of multiple threads (i.e., a first thread (T0) and a second thread (T1) in the embodiment of FIG. 4). However, it is to be understood that such thread-level mechanisms may be present for additional threads. Still further, in some embodiments only a single such mechanism may be present for a single thread environment. When a detector 305 is deallocated, e.g., pursuant to a least recently used (LRU) algorithm or in another such manner, the count of demand accesses for the deallocated detector may be provided from its associated register 308 to first and second multiplexers 315a and 315b. First and second multiplexers 315a and 315b may receive inputs from registers for the amount of detectors present (e.g., 8 to 32 detectors, in some embodiments) and provide a selected input to a respective averager unit 330a and 330b.

Accordingly, based on a thread with which the deallocated detector 305 is associated, the corresponding count from register 308 is provided through one of first and second multiplexers 315a and 315b to a corresponding thread averager 330a and 330b. For purposes of the discussion herein, the mechanism with respect to first thread (i.e., T0) will be discussed. However, it is to be understood that an equivalent path and similar control may occur in other threads (e.g., T1). Thread averager 330a may take the accumulated count value and accumulate it with a current count value present in a register 332a associated with thread averager 330. This accumulated value corresponds to a total number of accesses for a given number of detector lifetimes. Specifically, upon each deallocation and transmission of an access count a sample counter 320a is incremented and the incremented value is stored in an associated register 322a. Upon this incrementing, the incremented value is provided to a first logic unit 325a, which may compare this incremented sample count to a preset threshold. This preset threshold may correspond to a desired number of sample lifetimes to be analyzed. As described above, in some implementations this sample lifetime value may be a power of two and may correspond to 16 or 32, in some embodiments. Accordingly, when the desired number of sample lifetimes has been obtained and its demand access counts accumulated in thread averager 330a, first logic 325a may send a control signal to enable the averaging of the total number of demand accesses. In one embodiment, such averaging may be implemented by dropping off the least significant bits (LSBs) of register 332a via presence of a second register 334a coupled thereto. In one embodiment, register 332a may be 11 bits wide, while register 334a may be six bits wide, although the scope of the present invention is not so limited.

When the averaged value corresponding to average demand accesses per detector lifetime is obtained, the value may be provided to a second logic unit 335a. There, this average value may be compared to a threshold. This threshold may correspond to a level above which unconstrained prefetching may be allowed. In contrast, if the value is below the threshold, throttling of prefetching may be enabled. In various embodiments, the threshold may be empirically determined and in some embodiments, for example, where detectors have a depth of 32 to 128 entries, this threshold may be between approximately 5 and 15, although the scope of the present invention is not so limited. Thus based on the average number of accesses, it may be determined whether detector-based prefetching will improve performance. If, for example, the average is sufficiently low detector-based prefetching may not improve performance and thus may be throttled. Accordingly, a threshold value T between 1 and N may be set such that prefetching is throttled if the average is less than T, while prefetching may be enabled if the average is greater than T.

Accordingly, an output from second logic 335a may correspond to a prefetch throttling policy. Note that this throttle policy may be independently set and controlled for these different threads. If throttling is enabled (i.e., prefetching is throttled), the signal may be set or active, while if throttling is disabled, the signal may be disabled or logic low, in one implementation. As shown in FIG. 4, a throttle control signal 338 may be provided to each detector 305. More particularly, throttle control signal 338 may be provided to third logic unit 345 of detector 305. This throttle control signal 338 may thus be processed by third logic unit 345 to set an initial throttle policy when a detector 305 is allocated.

Because of transient or other behavior, a given allocated detector may see a relatively high level of demand accesses. If the number of demand accesses for an allocated detector is greater than an override threshold, which may be stored in third logic 345, for example, a set throttle policy may be disabled. Because some applications may exhibit a behavior that causes a low overall number of average accesses with periodic relatively high demand accesses, an override mechanism may be present. Thus to improve performance where prefetching may aid and thus reduce latency, if a particular detector has a number of accesses that exceeds the override threshold, throttling may be disabled and prefetching re-enabled for the given detector. Accordingly, prefetching may be enabled for a given detector if the actual number of demand accesses for a given detector 305 is greater than this override threshold. Thus, third logic unit 345 may enable prefetching decisions made in detector 305 to be output via prefetch output line 304. While described with this particular implementation in the embodiment of FIG. 4, it is to be understood that various embodiments may use other components and combinations of hardware, software and/or firmware to implement control of prefetch throttling.

Using embodiments of the present invention in a multi-threaded environment, prefetches may be throttled when they are less likely to be used. Specifically, threads in which a relatively high number of memory accesses per detector occur may perform prefetching. Such threads may benefit from prefetching. However, in applications or threads in which a relatively low number of demand accesses per detector lifetime occur, prefetching may be throttled. In such threads or applications, prefetching may provide little benefit or may negatively impact performance. Furthermore, because demand accesses may be temporal in nature, override mechanisms may enable prefetching in a thread in which prefetching is throttled to accommodate periods of relatively high demand accesses per detector lifetime.

Embodiments may implement thread prefetch throttling using a relatively small amount of hardware, which may be wholly contained within a prefetcher, reducing communication between different components. Furthermore, demand access detection and corresponding throttling may be performed on a thread-specific basis and may support heterogeneous workloads. Embodiments may be dynamically adaptive to quickly adapt and accommodate for transient behavior that may enable prefetching when it can improve performance. Furthermore, by throttling prefetching in certain environments, power efficiency may be increased, as only a fraction of unconstrained prefetches may be issued. Such power reduction may improve performance in a portable or mobile system which may often operate on battery power.

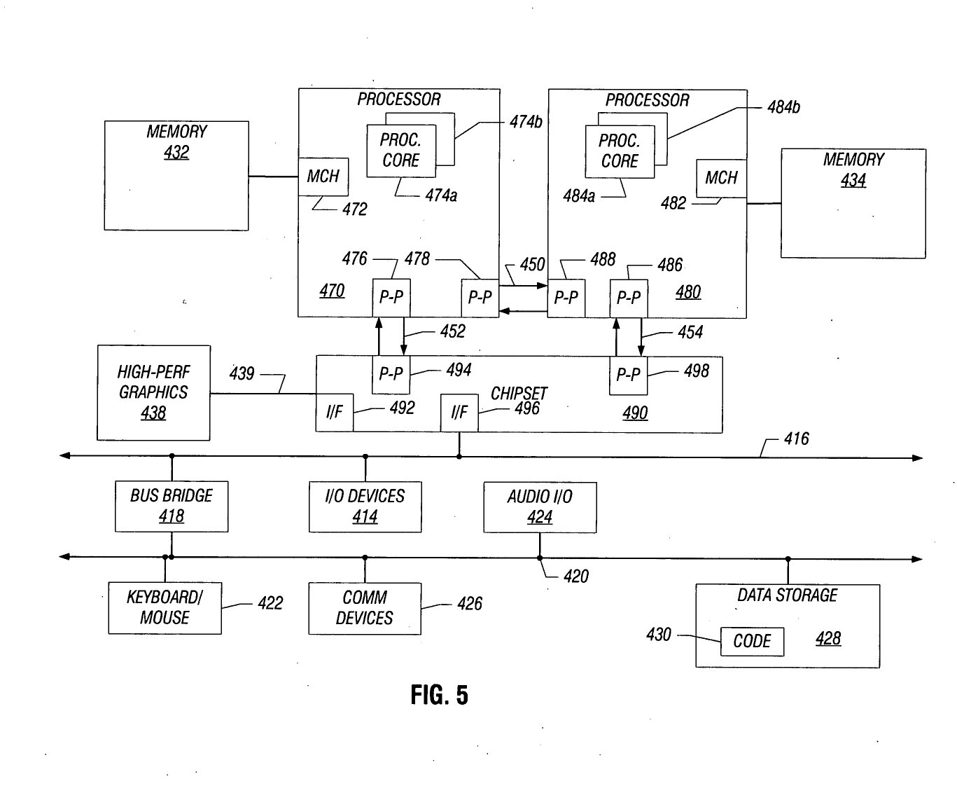

Embodiments may be implemented in many different system types. Referring now to FIG. 5, shown is a block diagram of a multiprocessor system in accordance with an embodiment of the present invention. As shown in FIG. 5, the multiprocessor system is a point-to-point interconnect system, and includes a first processor 470 and a second processor 480 coupled via a point-to-point interconnect 450. As shown in FIG. 5, each of processors 470 and 480 may be multicore processors, including first and second processor cores (i.e., processor cores 474a and 474b and processor cores 484a and 484b). While not shown for ease of illustration, first processor 470 and second processor 480 (and more specifically the cores therein) may include prefetch throttling logic in accordance with an embodiment of the present invention. First processor 470 further includes a memory controller hub (MCH) 472 and point-to-point (P-P) interfaces 476 and 478. Similarly, second processor 480 includes a MCH 482 and P-P interfaces 486 and 488. As shown in FIG. 5, MCH's 472 and 482 couple the processors to respective memories, namely a memory 432 and a memory 434, which may be portions of main memory locally attached to the respective processors.

First processor 470 and second processor 480 may be coupled to a chipset 490 via P-P interconnects 452 and 454, respectively. As shown in FIG. 5, chipset 490 includes P-P interfaces 494 and 498. Furthermore, chipset 490 includes an interface 492 to couple chipset 490 with a high performance graphics engine 438. In one embodiment, an Advanced Graphics Port (AGP) bus 439 may be used to couple graphics engine 438 to chipset 490. AGP bus 439 may conform to the Accelerated Graphics Port Interface Specification, Revision 2.0, published May 4, 1998, by Intel Corporation, Santa Clara, Calif. Alternately, a point-to-point interconnect 439 may couple these components.

In turn, chipset 490 may be coupled to a first bus 416 via an interface 496. In one embodiment, first bus 416 may be a Peripheral Component Interconnect (PCI) bus, as defamed by the PCI Local Bus Specification, Production Version, Revision 2.1, dated June 1995 or a bus such as the PCI Express bus or another third generation input/output (I/O) interconnect bus, although the scope of the present invention is not so limited.

As shown in FIG. 5, various I/O devices 414 may be coupled to first bus 416, along with a bus bridge 418 which couples first bus 416 to a second bus 420. In one embodiment, second bus 420 may be a low pin count (LPC) bus. Various devices may be coupled to second bus 420 including, for example, a keyboard/mouse 422, communication devices 426 and a data storage unit 428 which may include code 430, in one embodiment. Further, an audio I/O 424 may be coupled to second bus 420. Note that other architectures are possible. For example, instead of the point-to-point architecture of FIG. 5, a system may implement a multi-drop bus or another such architecture.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
counting demand accesses of a first thread associated with a prefetch detector to obtain a count value;
accumulating the count value with an accumulated count at deallocation of the prefetch detector; and
throttling prefetching in the first thread based on an average obtained from the accumulated count.

2. The method of claim 1, further comprising overriding the throttling if the count value for a selected prefetch detector is greater than an override threshold, and prefetching addresses determined by the selected prefetch detector based on the demand accesses.

3. The method of claim 1, further comprising generating the average when a sample number of prefetch detector deallocations have occurred.

4. The method of claim 1, further comprising applying the prefetch throttling to a newly allocated prefetch detector if the average is less than a first threshold.

5. The method of claim 4, further comprising overriding the prefetch throttling if the count value of demand accesses to the newly allocated prefetch detector exceeds an override threshold.

6. The method of claim 1, further comprising applying a throttling policy to a newly allocated prefetch detector based on comparison of the average to a first threshold, wherein the newly allocated prefetch detector is associated with the first thread.

7. The method of claim 6, further comprising applying a throttling policy of a second thread to a second newly allocated prefetch detector associated with the second thread, wherein the throttling policy of the second thread is independent of the throttling policy of the first thread.

8. An apparatus comprising:
a plurality of prefetch detectors to generate prefetch addresses, each of the plurality of prefetch detectors allocatable to monitor demand accesses to a memory region; and
a prefetch throttle unit coupled to the plurality of prefetch detectors, the prefetch throttle unit to apply a throttle policy to a first thread based on an average access count for the plurality of prefetch detectors associated with the first thread.

9. The apparatus of claim 8, wherein the prefetch throttle unit is to apply the throttle policy to a newly allocated prefetch detector associated with the first thread.

10. The apparatus of claim 8, wherein the prefetch throttle unit is to set the throttle policy to prevent prefetching based upon a comparison between the average access count and a threshold value.

11. The apparatus of claim 10, further comprising override logic to override the throttle policy for a prefetch detector and to enable transmission of the prefetch addresses from the prefetch detector if the demand accesses to the memory region allocated to the prefetch detector exceed an override threshold.

12. The apparatus of claim 8, wherein the prefetch throttle unit comprises an accumulator to obtain a total access count corresponding to a sample count of prefetch detector allocation cycles.

13. The apparatus of claim 12, further comprising a first logic to initiate generation of the average access count from the total access count when the sample count has been reached.

14. The apparatus of claim 8, wherein the prefetch throttle unit is to enable prefetches of a second thread and to apply the throttle policy to throttle prefetches of the first thread, wherein the first thread and the second thread are to be simultaneously executed in a processor core.

15. A system comprising:
a processor including a first core and a second core, the processor further including a cache coupled to the first core and the second core, wherein the first core includes a throttler to throttle prefetch signals from the first core based on analysis of demand accesses issued by the first core; and
a dynamic random access memory (DRAM) coupled to the processor.

16. The system of claim 15, wherein the throttler is to throttle prefetch signals for a first thread based on the analysis and to enable prefetch signals for a second thread based on the analysis.

17. The system of claim 16, wherein the throttler is to determine an average access count for a plurality of memory regions associated with the first thread and a plurality of memory regions associated with the second thread.

18. The system of claim 17, wherein the throttler is to throttle prefetch signals for the first thread based on a comparison of the associated average access count to a first threshold.

19. The system of claim 16, wherein the throttler is to enable prefetch signals for a memory region associated with the first thread when demand accesses for the memory region exceed a second threshold.

20. The system of claim 15, wherein the throttler is to apply a throttle policy of a first thread to a newly allocated prefetch detector associated with the first thread.

21. The system of claim 20, wherein the throttler further comprises override logic to override the throttle policy if demand accesses associated with the newly allocated prefetch detector exceed an override threshold.

22. An article comprising a machine-readable storage medium including instructions that if executed by a machine enable the machine to perform a method comprising:
tracking demand accesses by a processor for memory spaces allocated to prefetch detectors;
determining an average access count per prefetch detector allocation lifetime; and
throttling prefetching in the processor based at least in part on the average access count.

23. The article of claim 22, wherein the method further comprises throttling the prefetching on a per thread basis, wherein the processor comprises a multicore processor.

24. The article of claim 22, wherein the method further comprises comparing the average access count to a first threshold and throttling the prefetching if the average access count is below the first threshold.

25. The article of claim 24, wherein the method further comprises overriding the throttling if demand accesses for an allocated prefetch detector exceed an override threshold.

26. The article of claim 22, wherein the method further comprises setting a throttle policy for a first thread based on the average access count.

27. The article of claim 26, wherein the method further comprises applying the throttle policy to a newly allocated prefetch detector associated with the first thread.
